(19) United States
(12) Patent Application Publication
(10) Pub. No.: US 2008/0032093 A1
(43) Pub. Date: Feb. 7, 2008

(54) Cover plate for a portable electronic device and manufacturing method thereof

(75) Inventors: Bar-Long Deng, (US); Po-An Lin, (US); Chung-Nan Liu, (US)

Correspondence Address: BIRCH STEWART KOLASCH & BIRCH, PO BOX 747, FALLS CHURCH, VA, 22040-0747, US

(73) Assignee: COMPAL ELECTRONICS, INC.

(21) Appl. No.: 11/806,500

(22) Filed: May 31, 2007

(30) Foreign Application Priority Data
Aug. 4, 2006 (TW) 95128686

(51) Int. Cl. B32B 3/10; B29C 65/00; B32B 17/06; B32B 27/32; B32B 27/36

(52) U.S. Cl. 428/137; 156/286; 428/332; 428/411.1; 428/412; 428/426; 428/521

(57) ABSTRACT

A cover plate of a portable electronic device has an outer plate, an inner plate, and a protective layer. The protective layer is arranged between the outer plate and the inner plate, and the protective layer is a uniform reticulated structure. The outer further includes first a plating, a second plating and a third plating. Moreover, the method for fabricating the cover plate is also disclosed herein.

### RELATED APPLICATION

This application claims priority to Taiwan Application Serial Number 95128686, filed Aug. 4, 2006, which is herein incorporated by reference.

### BACKGROUND

1. Field of Invention

The present invention relates to a cover plate and a manufacturing method thereof. More particularly, the present invention relates to a cover plate for a portable electronic device and a manufacturing method thereof.

2. Description of Related Art

Portable electronic devices have undergone rapid development in the market, and have developed diversified functions over the past few years. People can enjoy entertainment information and work everywhere due to the wireless function of portable electronic devices. The cell phone and the laptop are the most popular working and entertainment apparatus of all the portable electronic devices.

To increase the portability of the laptop, the thickness and weight must be reduced and the operational usage time and the structural strength increased. However, reducing the thickness and improving the structural strength of the laptop clash with each other in some design parameters. For example, due to the improvement of the light emitting diode, the back-light module of the laptop display reduces the weight and thickness, but also deprives the structural strength of the display. Moreover, the laptop, being portable, has to withstand thrust because in a crowded environment. Therefore, improving the structural strength and reducing the thickness of the laptop is an objective of the companies.

In general, the upper plate covering the liquid crystal panel has varied structural design to improve the structural strength. For example, redesigning the upper plate into the arc shape for dispersing the thrust. However, the arc shape will increase the thickness of the laptop. It is difficult to balance the thickness and structural strength of the laptop.

Therefore, there is still room for improving the design of the cover plate of the portable electronic device to meet the demands of thickness and structural strength of the portable electronic device.

### SUMMARY

The current embodiment describes a cover plate of a portable electronic device including an outer plate, an inner plate and a protective layer. The protective layer is arranged between the outer plate and the inner plate, and the protective layer is a uniform reticulated structure.

According to another embodiment of the present invention, a method for fabricating a cover plate of a portable electronic device including the steps of providing an outer plate and an inner plate, and spreading an adhesive on a face of the outer plate and the inner plate separately. Subsequently, arranging a protective layer between the outer plate and the inner plate wherein the protective layer is a uniform reticulated structure. Finally, adhering the protective layer onto the outer plate and the inner plate in a vacuum treatment.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a exploded figure of the cover plate of the portable electronic device according to the first embodiment of this invention; and

FIG. 2 depicts the reticulated structure of the protective layer; and

FIG. 3 depicts the flow chart of the method for fabricating the cover plate of the portable electronic device; and

FIG. 4 is a exploded figure of the cover plate of the laptop according to the second embodiment of this invention; and

FIG. 5 is a exploded figure of the outer plate according to the second embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

All of the embodiments of this invention have a protective layer with a uniform reticulated structure to improve structural strength with similarities to the honeycomb structure. Someone skilled in the art could vary the application for other situations, and change the parameters of the structure and the material for a variety of designs.

### First Embodiment

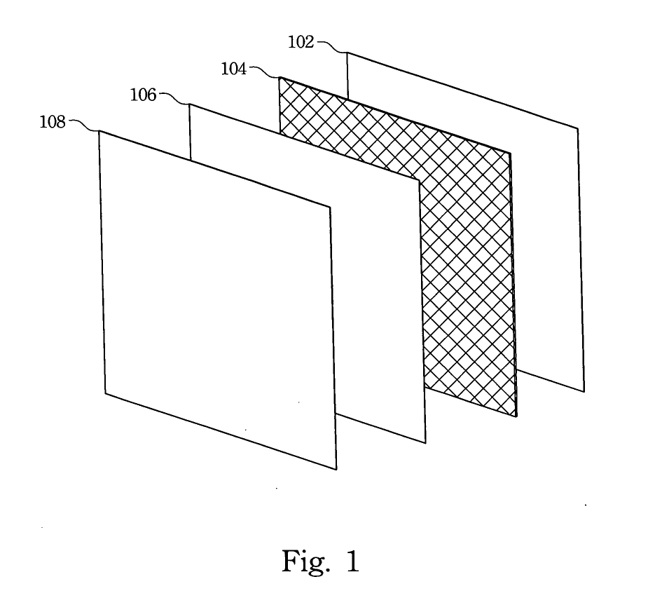

Please refer to FIG. 1. FIG. 1 depicts the exploded figure of the cover plate of the portable electronic device. The cover plate includes an outer plate 102, a protective layer 104, a inner plate 106, and a shielding layer 108. The protective layer 104 is a uniform reticulated structure, and configured between the inner plate 106 and the outer plate 102. The shielding layer 108 is arranged on the inner plate 106 surface facing away from the protective layer 104.

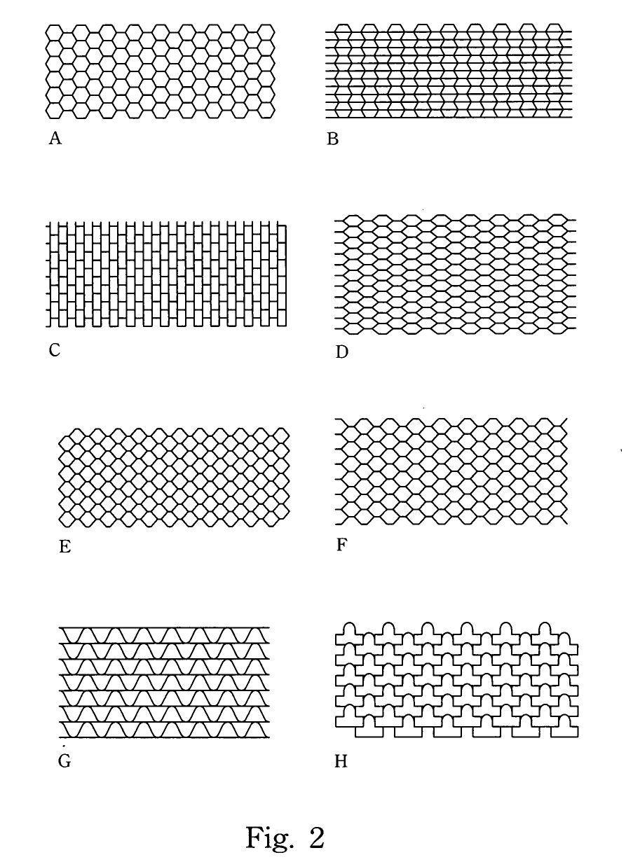

The uniform reticulated structures of the protective layer 104 are shown as FIG. 2. FIG. 2 is a diagram showing the reticulated structure of the protective layer 104. There are eight structures in this figure. However, the varying structures of reticulation are not limited in this figure. The reticulated structure can improve the structural strength more effectively. Moreover, most of the area of the protective layer 104 is hollow due to the reticulated structure. Therefore, the reticulated protective layer 104 is lighter and fairly firm.

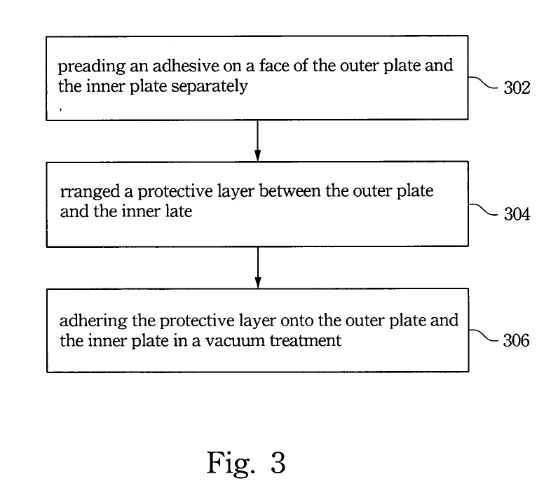

FIG. 3 depicts the flow chart of the method for fabricating the cover plate. To more impress the fabricating method and the disposition of the cover plate, please refer to FIG. 1 and FIG. 3 together. In the step 302, the inner plate 106 and the outer plate 102 are provided, and an adhesive is separately spread on one surface of the outer plate 102 and on one surface of the inner plate 106 . Subsequently, in step 304, the protective layer 104 is arranged between the outer plate 102 and the inner plate 106. The surface spread with the adhesive of the outer plate 102 and the inner plate 106 faces the protective layer 104, and the protective layer 104 is a uniform reticulated structure. Finally, in step 306, the protective layer 104 adheres onto the outer plate 102 and the inner plate 106 tightly in a vacuum treatment. Therefore, the thrust force is dispersed on the protective layer 104, and the foreign materials can not enter into the reticulated structure of the protective layer 104.

The adhesive is epoxy resins or polyurethane. The protective layer 104 adheres to the outer plate 102 and the inner plate 106 in the vacuum treatment at a temperature of 120° C.˜130° C. Therefore, this step rids the outer plate 102 and the inner plate 106 of the moisture, and the outer plate 102 and the inner plate 106 adhere to the protective layer 104 tightly. In this embodiment, the protective layer 104 is a uniform reticulated structure with high structure strength. Hence, the thickness of the protective layer 104 is at least about 0.1 mm, and the aperture size of the uniform reticulated structure is about 0.3 mm to 5 mm. The outer plate 102 and the inner plate 106 are made of a glass fiber composite material or a carbon fiber composite material. The whole thickness of the cover plate is at least about 1.2 mm˜1 mm.

The protective layer 104 can made of a variety of materials. Generally, the protective layer 104 must include the reticulated structure, and have the parameters of the aperture size close to the numbers described above. In this embodiment, the protective layer 104 is made of aluminum metal or sheet fiber. However, the materials of the protective layer 104 are not limited to metal, composite material, and plastic. Aluminum, Kevlar, nomex, kraft paper, and fiber paper can be designed in the reticulated structure as the protective layer 104. The choice of the variety of materials depends on the cost and the design.

The shielding layer 108 is composed of a conducting material, a conducting paint spread on the inner plate 106 surface facing away from the protective layer 104, or a conducting metal sputtered on the inner plate 106 surface facing away from the protective layer 104. Therefore, the display panel covered by the cover plate can prevent the electromagnetic interference due to the screening effect of the shielding layer 108.

### Second Embodiment

The object of the portable electronic device is to enable users to enjoy the digital information and work anywhere. Besides the lower weight and increased structural strength, the aesthetic appeal of the electronic device is very important to satisfy the user's feeling. Especially the laptop, besides the portability, the appearance will attract potential customers and increase competition and value of the laptop.

Therefore, this embodiment applies the first embodiment to design the cover plate of the laptop to increase the structural strength, reduce the thickness and weight of the laptop cover plate, and design a patents and brand label on the cover plate to improve the value of the laptop.

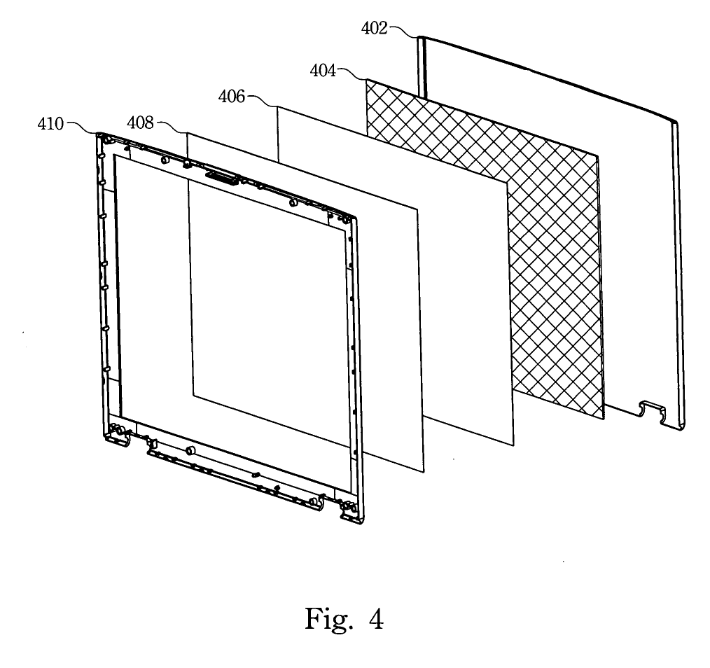

Please refer to FIG. 4. FIG. 4 depicts an exploded figure of the cover plate of the laptop according to the second embodiment of this invention. The cover plate includes an outer plate 402, a protective layer 404, an inner plate 406, a shielding layer 408, and a frame 410. The protective layer 404 is arranged between the inner plate 406 and the outer plate 402, and is a uniform reticulated structure. The shielding layer 408 is arranged on the inner plate 406 surface facing away from the protective layer 404. The frame 410 is gummed on the shielding layer 408 or formed on the shielding layer 408 by injection molding.

The structure specifics and the material choice conditions of the protective layer 404 are same as the first embodiment, and not further described herein. The difference between the first embodiment and the second embodiment is the design of the outer plate 402. The frame 410 has a pivot joint structure to combine with the main body of the laptop and the display panel. Moreover, the frame 410 also encircles the display panel and combines the cover plate and the display panel.

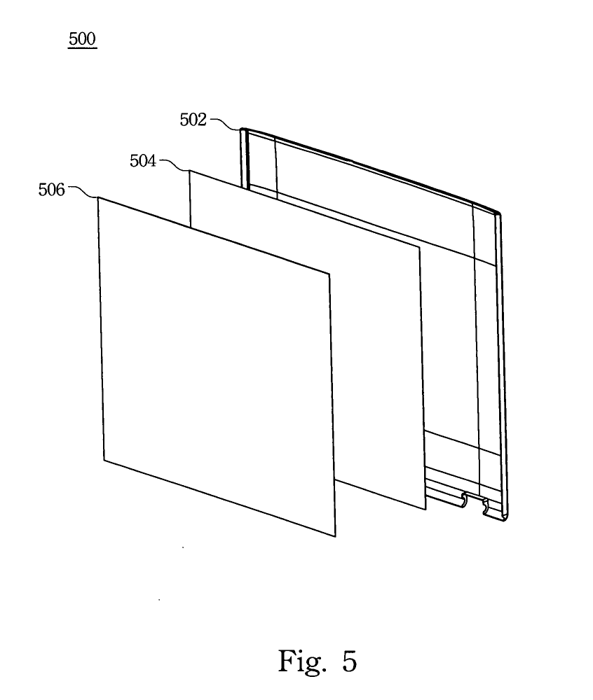

To easily design the appearance of the outer plate 402, please refer to FIG. 4 and FIG. 5 together. This figure depicts an exploded figure of the outer plate 402 in accordance with the second embodiment of this invention. The outer plate structure 500 has three layers, first plating 502, second plating 504, and third plating 506 in this embodiment. The second plating 504 is arranged between the first plating 502 and the third plating 506, and the first plating 502 and the third plating 506 are made of the same material.

The material of the first plating 502 and the third plating 506 is polycarbonate, acrylonitrile-butadiene-styrene copolymer, or the combination thereof. Due to the plasticity of the plastics material, the first plating 502 surface facing away from the second plating 504 can be designed with a shape or a pattern for embellishing the cover plate. Moreover, the second plating 504 is made of a glass fiber composite material or a carbon fiber composite material, and arranged between the first plating 502 and the third plating 506 to increase the structural strength of the outer plate structure 500.

In addition, the third plating 506 of the outer plate 500 is also made of the plastics material with high plasticity. Besides being gummed to the protective layer 404 by the adhesive as the first embodiment, the third plating 506 and the frame 410 can be designed a mounting structure thereon. The mounting structure fastens the protective layer 404, inner plate 406, and shielding layer 408 between the outer plate 402 and the frame 410. Therefore, the protective layer 404 can be changed faster, and reduce the time of mass production.

The shielding layer 408 is composed of a conducting material, a conducting paint spread on the inner plate 406 surface facing away from the protective layer 404, or a conducting metal sputtered on the inner plate 406 surface facing away from the protective layer 104. The shielding layer 480 can prevent the display panel covered by the cover plate from the electromagnetic interference due to the screening effect of the shielding layer 108.

Accordingly, all of the embodiments have the protective layer with the uniform reticulated structure to improve the structure strength of the cover plate. Hence, the cover plate reduces the thickness and the weight effectively, and balances the structure strength and the thickness. Generally, the reticulated structure is chosen among many materials according to the specific parameters described above. Therefore, the choice of the variety of materials depends on the cost and the design.

Besides the unitary material, the outer plate can be changed to a multi layer structure. Due to the plasticity of the plastic material, the cover plate of the portable electronic device can be designed. When the embodiment is applied to the cover plate of the laptop, it is easy to design a wonderful appearance and the brand label on the cover plate, and increase the value of the laptop.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A cover plate of a portable electronic device, comprising:
an outer plate;
an inner plate; and
a protective layer arranged between the outer plate and the inner plate, wherein the protective layer is a uniform reticulated structure.

2. The cover plate of claim 1, wherein the outer plate comprises a first plating, a second plating, and a third plating, the second plating is arranged between the first plating and the third plating.

3. The cover plate of claim 2, wherein the first plating and the third plating are made of same material.

4. The cover plate of claim 3, wherein the material of the first plating and the third plating is polycarbonate, acrylonitrile-butadiene-styrene copolymer, or the combination thereof.

5. The cover plate of claim 2, wherein the second plating is made of a glass fiber composite material or a carbon fiber composite material.

6. The cover plate of claim 1, wherein the outer plate and the inner plate are made of a glass fiber composite material or a carbon fiber composite material.

7. The cover plate of claim 1, wherein the thickness of the protective layer is at least about 0.1 mm.

8. The cover plate of claim 1, wherein the aperture size of the uniform reticulated structure is about 0.3 mm to 5 mm.

9. The cover plate of claim 1, further comprises a shielding layer arranged on the inner plate surface facing away from the protective layer, wherein the shielding layer is composed of a conducting material.

10. The cover plate of claim 1, wherein the inner plate surface facing away from the protective layer is spread on a conducting paint or sputtered on a conducting metal.

11. A method for fabricating a cover plate of a portable electronic device, comprising:
(a) providing an outer plate and an inner plate, and spreading an adhesive on a surface of the outer plate and the inner plate separately;
(b) arranging a protective layer between the outer plate and the inner late, wherein the protective layer is a uniform reticulated structure;
(c) adhering the protective layer onto the outer plate and the inner plate in a vacuum treatment.

12. The method of claim 11, wherein the adhesive is epoxy resins or polyurethane.

13. The method of claim 11, wherein the thickness of the protective layer is at least about 0.1 mm and the uniform reticulated structure is about 0.3 mm to 5 mm.

14. The method of claim 11, wherein the step (c) is performed in 120° C.˜130° C.

15. The method of claim 11, wherein the vacuum treatment rids the outer plate and the inner plate of the moisture.

16. The method of claim 11, wherein after step (c) further comprises a step of:
(d) forming a shielding layer on the inner plate surface facing away from the protective layer.

17. The method of claim 16, wherein the shielding layer is a conducting paint spread on the inner plate surface or a conducting metal sputtered on the inner plate surface.

18. The method of claim 16, wherein after step (d) further comprises a step of:
placing a frame on the shielding layer.

19. The method of claim 18, wherein the frame is gummed on the shielding layer or formed on the shielding layer by injection molding.
